(19) United States
(12) Patent Application Publication
(10) Pub. No.: US 2013/0230233 A1
(43) Pub. Date: Sep. 5, 2013

(54) Method for Reconstruction of Multi-Parameter Images of Oscillatory Processes in Mechanical Systems

(71) Applicants: Anatoly Alekseevich Speranskiy, Moscow (RU); Alexander Igorevich Prokhorov, Moscow (RU)

(72) Inventors: Anatoly Alekseevich Speranskiy, Moscow (RU); Alexander Igorevich Prokhorov, Moscow (RU)

(21) Appl. No.: 13/812,494

(22) PCT Filed: Jul. 28, 2010
(86) PCT No.: PCT/RU10/00419

§ 371 Date: May 23, 2013

(51) Int. Cl. G06K 9/00

(52) U.S. Cl. CPC G06K 9/00201
USPC 382/154

(57) ABSTRACT

A method for investing vibration processes in elastic mechanical systems. The technical result of the proposed invention is the creation of a spectral set of multidimensional images, mapping time-related three-dimensional vector parameters of metrological, and/or design-analytical, and/or design vibration parameters of mechanical systems. Reconstructed images with various dimensionality that are integrated in various combinations depending on the target function can be used as a homeostatic portrait or a cybernetic image of vibration processes in mechanical systems for objective evaluation of current operating conditions in real time. The invention can be widely used for improving the effectiveness of monitoring and investigating vibration processes in mechanical systems (objects) in the fields of mechanical engineering, construction, acoustics, etc.

### CROSS-REFERENCE TO RELATED APPLICATION

This application claims the benefit of the priority filing date in PCT/RU2010/000419 and referenced in WIPO Publication No. WO2012/015326. The earliest priority date claimed is Jul. 28, 2010.

### FEDERALLY SPONSORED RESEARCH

None

### SEQUENCE LISTING OR PROGRAM

None

### BACKGROUND

The invention relates to the investigation of vibration processes in elastic mechanical systems used in mechanical engineering, construction, acoustics, and other fields.

Known are methods for monitoring machines and structures during operation or testing, which are described in patents RU 2194971, U.S. Pat. No. 5,602,761, U.S. Pat. No. 6,763,312 and U.S. Pat. No. 7,225,109. These methods involve measuring the vibration parameters of machines or structures using vibration acceleration sensors to analyze the deformation parameter values of an element of an object at the point of sensor installation.

A disadvantage of known methods is the use of vibration acceleration sensors which measure the acceleration projection value on axis measuring sensors, but which do not determine the value and direction of the deformation vector (vibration displacement and its derivatives).

The closest analogue of the claimed invention is a method for monitoring machines and structures as evidenced in patent RU 2371691 of Apr. 22, 2008. This method involves the measurement of an object's vibration parameters using at least one object acceleration sensor, and determines and particularly calculates and analyzes vibration parameter values of an element of monitoring monitored object at the point of sensor installation. Herein, a sensor is used that synchronously measures three orthogonal projections of an acceleration vector. The value and direction of the monitored object's vibration vector at the point of sensor installation are determined. A set of vector values of deformation is accumulated over time. A space-time hodograph of the deformation vector relative to a coordinate system is connected to the monitored object and is displayed on a monitor for at least one vibration frequency. Then, the presence of anisotropy in the object's deformations is determined from the hodograph shape at the point of sensor installation.

A disadvantage of the known method is that it is not possible to reconstruct metrological and design-analytical spectral vibration parameters of time-related multidimensional images in a mechanical system's vibration processes. To efficiently and significantly increase the information content of vibration process measurements in mechanical systems through vector vibration accelerometers and 3D mechanical vibration transducers, multidimensional system-related parametric spectral images must be created of a vibration processes' diagnostic vibration parameters. Moreover, the images must be suitable for the natural and physical processes and phenomena under investigation.

The present invention solves the technical problem of improving the effectiveness of investigating and evaluating the status of vibration processes in mechanical systems. The technical solution of the stated problem is the proposed method for reconstructing multi-parameter images of vibration processes in mechanical systems; in particular, the creation of system-related, multi-parameter, and multi-level cybernetic images of a mechanical system's vibration processes that are hierarchically organized and two and three dimensional.

### SUMMARY

The proposed method comprises the following: creating a set of 3D elliptic images (hodographs) of vectors for linear vibration accelerations, vibration speeds, and/or vibration displacements [This must be done at measurement points where vector sensors (3D transducers) are installed. The 3D elliptic images are based on synchronously measured, three-dimensional and dynamic (time-varying) components of diagnostic parameter vectors]; accumulating a spectral set of measured (including approximated) and design vectors, and scalar values, in the selected frequency range of mechanical vibrations; plotting the measured and design diagnostic parameters of the monitored object at measurement points on a 3D model; presenting a 3D reconstruction of the spectral set of three-dimensional elliptic hodographs of the time-varying deformation vector values ; and deriving characteristic parameters of external force factors and positional relationship with respect to measurement points, as well as determining the stress-strain state from the values relationship and axes directions of the hodograph's ellipsoid deformation vector.

Metrologic and design vector parameters are physically interconnected tensorially. They are essential and systemic, and form a stable set of attributes that are well-fitted to physical nature mapping an object's dynamic homeostasis. An integral reconstructed image of vibration processes can be used during subsequent monitoring and control of the object.

The technical result is the creation of a spectral set of multidimensional images that map time-related three-dimensional, metrological and/or design-analytical vector parameters, and/or design vibration parameters, of mechanical systems. Reconstructed images with various dimensions that are integrated in various combinations based on target function can be used as a homeostatic portrait, or as a cybernetic image, of vibration processes in mechanical systems. They can then be used for objective evaluation of current operating conditions in real time. Said technical result is achieved in the proposed method for reconstructing images of vibration processes due to the fact that the device for implementing the method comprises a space-time measurement module, a module for synchronizing space-time transformation measurements, a digital memory module, a module for spectral processing of measured vector parameters, a module for reconstructing measured parameters, a module for tensor transformation of normalized matrices, a module for design diagnostic parameters of mechanical vibrations, a module for a 3D object model reconstruction, a module for reconstructing multi-parameter images of vibration processes, a module for visualizing reconstructed parameters, a documentation module, and a module for organizing system interaction of all modules.

In comparing the analogue to the proposed method, the common essential features are the methods' processes of measuring vibration parameters of mechanical systems in a specified frequency range using a 3D transducer of mechanical vibrations and determining the hodograph of the deformation vector for an element of the object under investigation. The distinctive essential features are that the proposed method comprises processes for creating a 3D model of the investigated object, mapping the measured and physically related design vector values of vibration processes on the model, determining the distribution of contour characteristics of the reconstructed parameters on the model, approximating parameters in three dimensions and measured continuously at specified discrete points on elements of the investigated object, creating graphic cuts and sections of contour characteristics of the reconstructed parameters, and extracting fronts of parameters and local zones based on specified criteria which makes it possible to create multi-parameter cybernetic images of an investigated object's vibration states.

The proposed invention is novel because the inventors have found nothing confirming use of the same method for the same purpose. The inventors know of no technical solutions that have features matching the essential features of the claimed method; therefore, the inventors think that the technical solution meets the “inventive level” criterion. The claimed invention can be widely used for improving the effectiveness of monitoring and investigating vibration processes in mechanical systems (objects) in the fields of mechanical engineering, construction, acoustics, etc. Therefore, the invention meets the “industrial applicability” criterion.

### DRAWINGS

FIG. 1 schematically show the structure for measuring and forming diagnostic parameters of mechanical vibrations

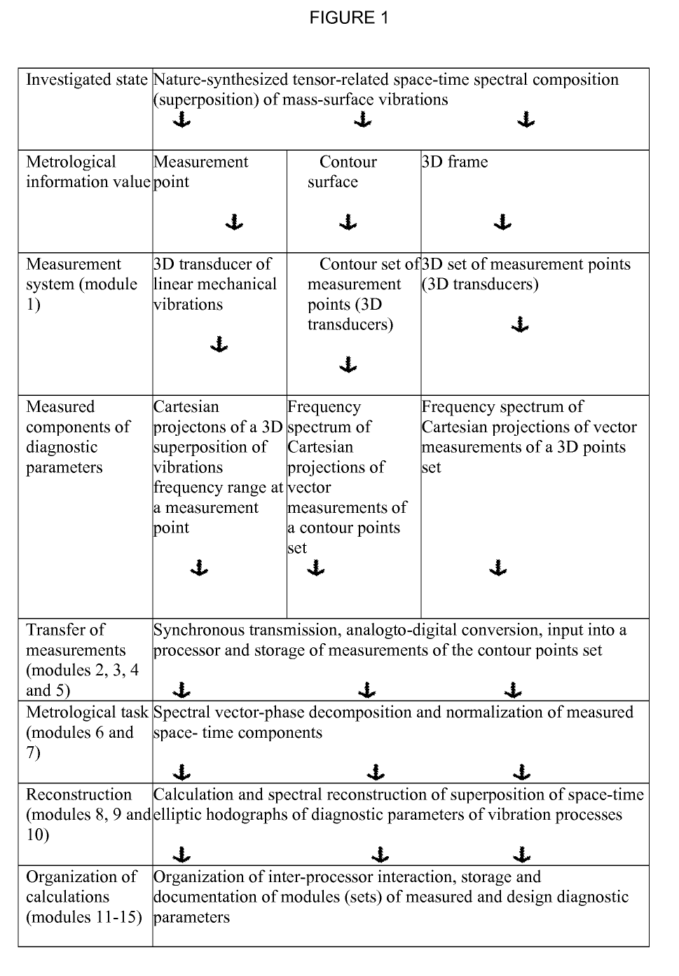

FIG. 2 is a block diagram of the device for reconstructing multi-parameter images of vibration processes in mechanical

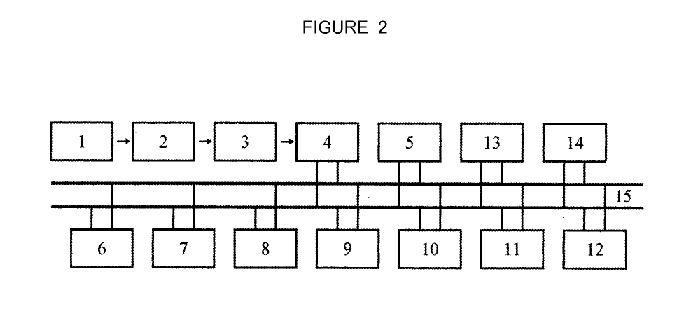

### REFERENCES

1—3D transducers of mechanical vibrations
2—three-channel modules for synchronous amplification and transformation of a charge
3—a device/module for synchronous transmission of measured components of parameters of mechanical vibrations
4—a device/module for synchronous analog-to-digital conversion of components of parameters of mechanical vibration and input of the components into a processor
5—a module/set of digital memory of measured components of parameters of mechanical vibrations
6—a module for spectral processing of measured components of parameters of mechanical vibrations
7—a module/set of normalized matrices of tensor transformation
8—a module/set for spectral reconstruction of elliptic hodographs of diagnostic space-time parameters at measurement points
9—a module/set for reconstruction of a 3D model of an object, a module/set for reconstruction of multi-parameter images of vibration processes
10—a module/set for reconstruction of multi-parameter images of vibration processes
11—a module for visualization of diagnostic parameters
12—a documentation module
13—a module for synchronizing transformation of space-time measurements
14—a module for organizing system interaction of all modules
15—information transmission and control buses.

### DETAILED DESCRIPTION

The method for reconstructing multi-parameter images of vibration processes in mechanical systems is realized as follows. When the spectrum of wave vibrations synthesized by external force factors (in the form of action forces and moments, or by internal pathologies of a structure's material) propagate over the contour surface and volume of an object, the vibrations act on the sensing elements of 3D transducers. The 3D transducers of mechanical vibrations are installed at measurement points of the object's contour surface. A metrological device performs reverse tensor transformation of the deformation spectrum acting on the metrological device. The metrological device also measures the space-time superposition of spectral set, metrology parameter components in a transducer's Cartesian coordinate system. The measured analogue parameters are synchronously converted to digital form and entered into digital memory for spectral processing (filtration) and vector-phase reconstruction of elliptic metrological parameter sets. To maintain the linearity of related metrological and design diagnostic parameters, it is necessary to normalize the measurements relative to maximum (limiting) values determined by metrology instrument engineering specifications and by design coefficients of physical quantities conversion.

A multidimensional related set of connected, reasonably necessary design metrological vibration parameters of vibration processes forms the essence of the cybernetic image of an object and determines the degree of its suitability for the nature-synthesized spectrum of mechanical vibrations. Then, depending on the stated objective, current values are calculated of diagnostic parameters that make it possible to judge the systemic dynamic state (homeostasis) of the object. In visualization and documentation modules of reconstructed parameters, graphic vector-phase images, including elliptic images, and scalar images, are formed that make objective analysis and efficient diagnostics of the current homeostatic state of the object possible. The validity of the object's cybernetic image is supported by the synchronous system interaction of all modules that form, process, store and map the set of processes for design metrological vibration parameters.

What is claimed:

1. A method for reconstructing multi-parameter images of vibration processes in mechanical systems comprising the steps of measuring vibration parameters of mechanical systems in a specified frequency range using a 3D transducer of mechanical vibrations, and determining the deformation vector of an element of an investigated object at the point of transducer installation, wherein the method further comprises the steps of creating a 3D model of the investigated object, mapping the vibration processes' spectrum of measured and physically related design vector and scalar parameters on the model, forming contour characteristics of reconstructed parameters, approximating three dimensions of continuously measured parameters at specified discrete points of elements of the investigated object, creating graphic cuts and sections of the contour characteristics of the reconstructed parameters, and graphically extracting local zones and fronts of diagnostic parameters based on specified criteria which makes it possible to create multi-parameter cybernetic images of vibration processes of a mechanical system's investigated objects.
